(19) United States
(12) Patent Application Publication
(10) Pub. No.: US 2005/0177443 A1
(43) Pub. Date: Aug. 11, 2005

(54) Systems and methods for reposting network auction items for resale

(75) Inventors: Herman Rodriguez, Austin, TX (US); Newton James Smith JR., Austin, TX (US)

Correspondence Address: Barry S. Newberger, 400 North Ervay Street, P.O. Box 50784, Dallas, TX, 75201, US

(73) Assignee: International Business Machines Corporation, Armonk, NY (US)

(21) Appl. No.: 10/758,861

(22) Filed: Jan. 16, 2004

(51) Int. Cl. G06F 17/60

(52) U.S. Cl. 705/26

(57) ABSTRACT

Systems and methods for reselling items won in a network auction are provided. In response to a query to the winning bidder in a network auction, the previously-auctioned item is reposted for resale using existing descriptive data. In other words, the winning bidder does not have to resubmit a description of the item to be resold. Additionally, previously unsuccessful bidders are notified that the previously-auctioned item is reposted for sale. A minimum bid price is set in response to a suggested minimum bid and a seller-specified minimum bid.

### TECHNICAL FIELD

The present invention relates to data processing systems, and in particular to data processing systems for online auctions including mechanisms for the reposting of items purchased in a network auction for resale by the successful bidder.

### BACKGROUND INFORMATION

Electronic auctions or equivalently, network auctions have become a very popular vehicle for the buying and selling of goods and services on the Internet. Commonly, items are purchased on the Internet for the purchasers' own use. However, many purchases in network auctions, are items purchased for resale, often for resale auctions. If the purchaser has acquired the item for resale, the purchaser must submit the item for posting in the same fashion as the original seller. This entails creating an account at the auction Web site, and specifying the item description, minimum bid and duration of the auction. Thus, the reseller is required to repeat tasks and provide information already previously entered by the original seller.

Hence, there is a need in the art for mechanisms to facilitate the resale of items purchased in network auctions.

### SUMMARY

The aforementioned needs are addressed by the present invention. Accordingly there is provided a method for reselling items in a network auction. In response to a query to the winning bidder in a network auction, the previously-auctioned item is reposted for resale using existing descriptive data. In other words, the winning bidder does not resubmit a description of the item to be resold. Additionally, previously unsuccessful bidders are notified that the previously-auctioned item is reposted for sale. A minimum bid price is set in response to a suggested minimum bid and a seller-specified minimum bid.

The foregoing has outlined rather broadly the features and technical advantages of one or more embodiments of the present invention in order that the detailed description of the invention that follows may be better understood. Additional features and advantages of the invention will be described hereinafter which form the subject of the claims of the invention.

### BRIEF DESCRIPTION OF THE DRAWINGS

For a more complete understanding of the present invention, and the advantages thereof, reference is now made to the following descriptions taken in conjunction with the accompanying drawings, in which:

FIG. 1 illustrates a network architecture which may be used in conjunction with the present invention;

FIGS. 2A and 2B illustrate a methodology for offering for resale, previously purchased items in a network auction in accordance with an embodiment of the present invention; and

FIG. 3 illustrates, in block diagram form, a data processing system which may be used in conjunction with the methodologies employed in the present inventive principles.

### DETAILED DESCRIPTION

In the following description, numerous specific details are set forth to provide a thorough understanding of the present invention. For example, particular notification intervals may be used to illustrate the present inventive principles. However, it would be recognized by those of ordinary skill in the art that the present invention may be practiced without such specific details, and in other instances, well-known circuits have been shown in block diagram form in order not to obscure the present invention in unnecessary detail. Refer now to the drawings, wherein depicted elements are not necessarily shown to scale and wherein like or similar elements are designated by the same reference numeral through the several views.

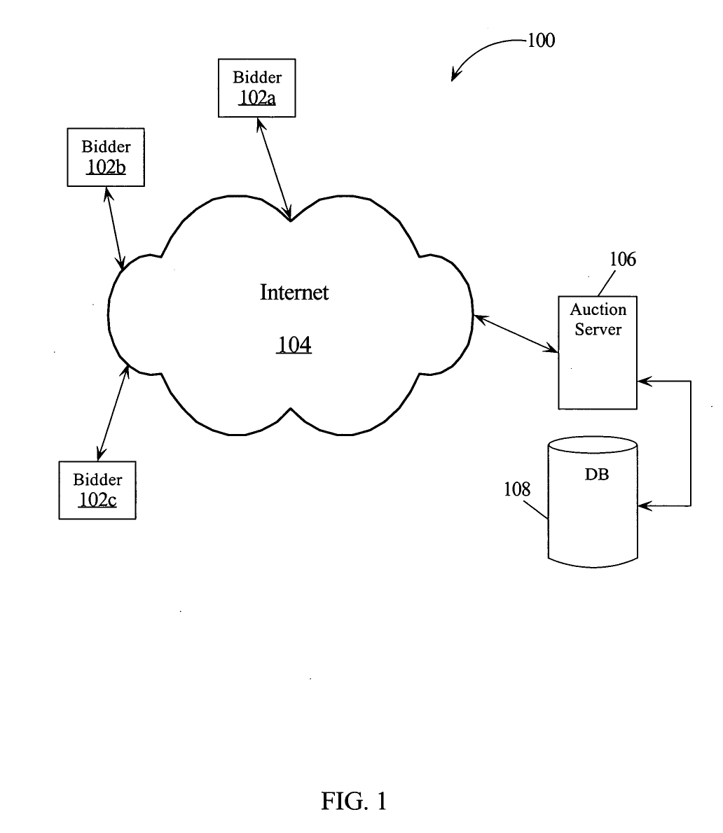

FIG. 1 illustrates a high-level network architecture for reselling auction items won in an Internet auction in accordance with the present inventive principles. Auction bidders are illustrated by bidders 102a-102c who bid in the auction over a network, here Internet 104. Bidders 102a-102c are representative, and it would be readily understood by persons of ordinary skill in the art that typically many more that three bidders may participate in a typical Internet auction. Auction server 106 receives bids until the auction (for a particular item) is terminated at a predetermined time. Auction data including descriptive information for the items offered as well as bid tracking data may be stored in database 108. Additionally, server 106 may also provide a successful bidder a mechanism for reselling the item won in the auction in accordance with the present inventive principles described further hereinbelow.

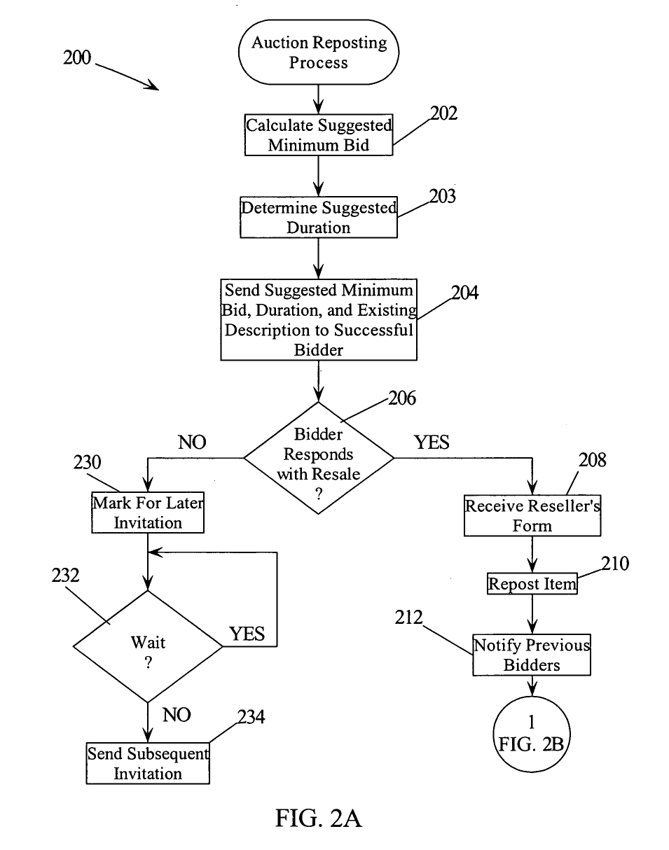

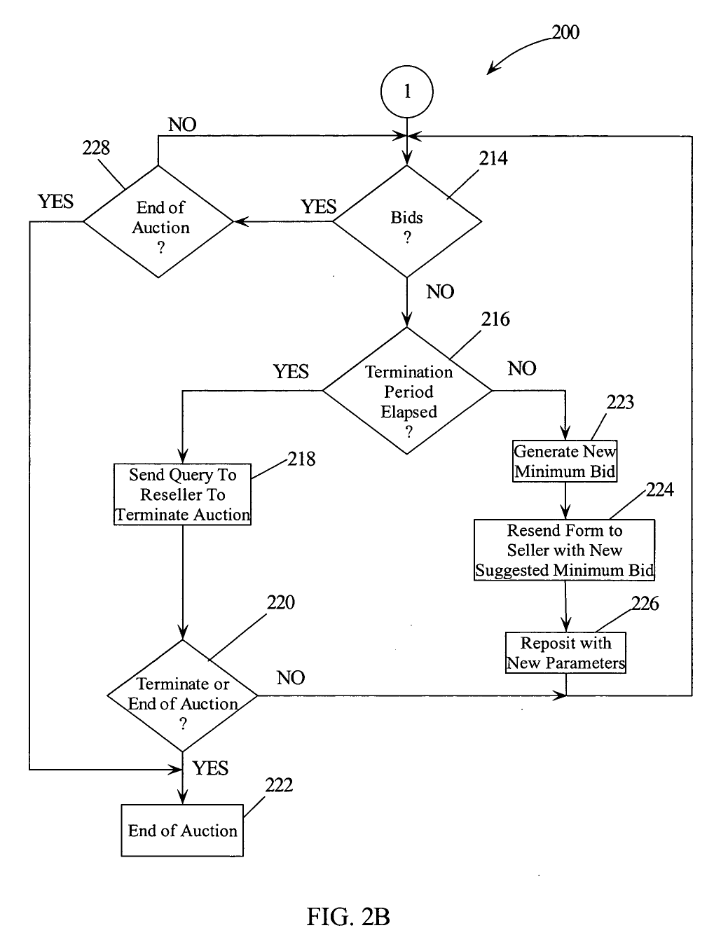

Refer now to FIG. 2 illustrating methodology 200 for reposting for sale items purchased in a network auction. The flowcharts provided herein are not necessarily indicative of the serialization of operations being performed in an embodiment of the present invention. Steps disclosed within these flowcharts may be performed in parallel. The flowcharts represent those considerations that may be performed to produce the operations available for the reposting of items purchased at auction for resale. It is further noted that the order presented is illustrative and does not necessarily imply that the steps must be performed in the order shown.

Commonly, a minimum bid set by a reseller is unreasonably high. In other words, the minimum bid desired by the seller may be markedly inconsistent with the historic auction activity. Such a minimum bid price may dampen bidding activity. Indeed it may quash any interest in the item altogether. Thus, in step 202 a suggested minimum bid is calculated. A suggested minimum bid may be determined by extrapolating from the previous bidding activity retrieved from the database. For example, a linear extrapolation using an average rate of increase of the bid price over the duration of the prior auction of the item may be used. If similar items have been auctioned, this data can be used to set the price. A word search matching the description of the item and other items can be used. The reseller can be shown these items in a list of the GUI and select or deselect those which should be used to calculate the minimum bid price. However, commonly, bidding activity is not uniform in time, with activity occurring in intervals that are only a fraction of the total duration of the auction. Thus, alternatively, an extrapolation using bidding rates from a most recent time interval, for example, the last hour, or other predetermined time interval may be used. Similarly, in another alternative embodiment, an extrapolation based on the time interval over the course of the prior auction having the most dramatic changes in the bid price may be used. In this way, a suggested minimum bid that better reflects the bidding habits of potential bidders for the item may be obtained. A suggested minimum bid may be generated using historical bid data for the item as tracked in the prior auction. Additionally, in step 203, a suggested duration of an auction of an item offered for resale is determined. This may be the duration of the previous auction, or alternatively determined by a percentage of the duration of the previous auction, for example. Another alternative is to track the bidding activity of the previous auction and use the duration of the interval of time over which a predetermined percentage, say fifty-one percent, of the bids were placed.

In step 204, the suggested minimum bid, suggested duration and the existing description of the item from the previous auction is sent to the winning bidder, in conjunction with a query if the winning bidder wants to offer the previously-auctioned item for resale. The suggested minimum bid, suggested duration and description may be sent to the winning bidder in a pre-populated Web form, in fields editable by the recipient. If the pre-populated data is acceptable to the recipient winning bidder, he or she may return the form by, for example, clicking on a “Yes button” or similar device to return the page to the auction server. If the winning bidder wishes, the suggested values for the aforementioned parameters, as well as the description of the item, may be modified by the recipient, and returned to the auction site. If the modified price is unreasonable based historical data, the reseller can be warned via a dialog box.

If, with any modifications by the user in step 206, the successful bidder affirmatively responds with a resale, the reseller's form is received in step 208. In step 210, the item is reposted for auction. If the reseller has modified any of the pre-populated data, the reseller's values are used in the reposted auction. In step 212, the previous bidders are notified.

In step 214, after a predetermined period of time, it is determined if any bids have been received. If not, the suggested minimum bid generated in step 202, or alternatively the minimum bid set by the reseller, if modified as previously described, may be too high. Thus, in steps 223-226, the reseller may be offered the opportunity to reduce the minimum bid. Additionally, if no bids have been received even after a significant portion of the duration of the auction has elapsed, i.e., a second period, the reseller may be given the opportunity to terminate the auction altogether. Thus, in step 216, it is determined if a preselected termination period has elapsed. The period may be set as a fraction of the duration of the auction, say seventy-five percent, although other values may be used. The predetermined period of time may also be based on the history of similar auctions. If the period has elapsed, in step 218 a query is sent to the reseller to terminate the auction. If, in step 220, the reseller elects to terminate the auction or the duration of the auction previously set elapses, the auction ends in step 222. Otherwise, process 200 returns to step 214.

Returning to step 216, if the termination time period has not elapsed, in step 223 a new minimum bid is generated and the Web form with the new suggested bid contained therein sent to the reseller in step 228. The new minimum bid may be calculated as a percentage of the prior minimum bid, say eighty percent, but no lower than the purchase price. Alternatively, if the time interval used to generate the prior minimum bid was smaller than the auction duration, the new suggested minimum may be calculated by extrapolation using an average bid rate over the duration of the previous auction or similar auctions. In another alternative embodiment, the new minimum bid may be calculated by expanding the time interval of the largest bid activity in the previous auction or similar auctions. Additionally, a new suggested auction duration may also be included in the form. In step 226, the item is reposted with the new parameters, and process 200 returns to step 214.

If, in step 214, bids have been placed, steps 216-226 are bypassed, and in step 228, step 228, it is determined if the end of the auction has been reached. If so, the auction terminates in step 222.

Returning to block 206, if the successful bidder elects not to sell, in step 230, the successful bidder is tagged for a later invitation. Process 200 then waits a predetermined interval of time, say two weeks, in step 232. After the predetermined period of time elapses, a subsequent invitation to repost the item successfully acquired by a bid is sent to the successful bidder in step 234.

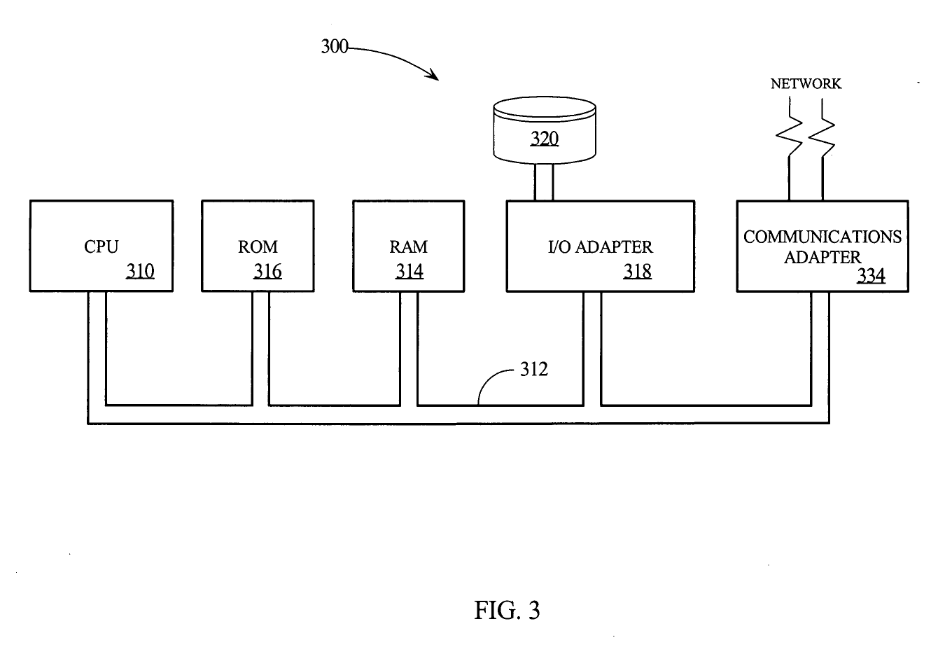

FIG. 3 illustrates an exemplary hardware configuration of data processing system 300 in accordance with the subject invention. The system in conjunction with the methodology illustrated in FIG. 2 may be used to provide a successful bidder in a network auction with a mechanism to offer the item for resale in accordance with the present inventive principles. Data processing system 300 includes central processing unit (CPU) 310, such as a conventional microprocessor, and a number of other units interconnected via system bus 312. Data processing system 300 also includes random access memory (RAM) 314, read only memory (ROM) 316 and input/output (I/O) adapter 318 for connecting peripheral devices such as nonvolatile storage units 320 to bus 312. System 300 also includes communication adapter 334 for connecting data processing system 300 to a data processing network, enabling the system to communicate with other systems. CPU 310 may include other circuitry not shown herein, which will include circuitry commonly found within a microprocessor, e.g. execution units, bus interface units, arithmetic logic units, etc. CPU 310 may also reside on a single integrated circuit.

Preferred implementations of the invention include implementations as a computer system programmed to execute the method or methods described herein, and as a computer program product. According to the computer system implementation, sets of instructions for executing the method or methods are resident in the random access memory 314 of one or more computer systems configured generally as described above. These sets of instructions, in conjunction with system components that execute them, may be used to provide a resale mechanism to a successful network auction bidder. Until required by the computer system, the set of instructions may be stored as a computer program product in another computer memory, for example, in nonvolatile storage unit 320 (which may include a removable memory such as an optical disk, floppy disk, CD-ROM, or flash memory). Further, the computer program product can also be stored at another computer and transmitted to the user's workstation by a local network or by an external network such as the Internet. One skilled in the art would appreciate that the physical storage of the sets of instructions physically changes the medium upon which they are stored so that the medium carries computer readable information. The change may be electrical, magnetic, chemical, biological, or some other physical change. While it is convenient to describe the invention in terms of instructions, symbols, characters, or the like, the reader should remember that all of these in similar terms should be associated with the appropriate physical elements.

Note that the invention may describe terms such as comparing, validating, selecting, identifying, or other terms that could be associated with a human operator. However, for at least a number of the operations described herein which form part of at least one of the embodiments, no action by a human operator is required or desirable. The operations described are, in large part, machine operations processing electrical signals to generate other electrical signals.

Although the present invention and its advantages have been described in detail, it should be understood that various changes, substitutions and alterations can be made herein without departing from the spirit and scope of the invention as defined by the appended claims.

1. A method for reselling items in a network auction comprising:
generating a suggested minimum bid and suggested auction duration for a previously-auctioned item;
sending the existing item description, suggested minimum bid and suggested auction duration to a winning bidder and querying said winning bidder to resell the previously-auctioned item;
responsive to a receipt of an affirmative reply from the winning bidder, reposting the previously-auctioned item for a new auction; and
notifying previously unsuccessful bidders that the previously-auctioned item is reposted.

2. The method of claim 1 further comprising generating said suggested minimum bid using historical bids from a previous auction of said previously-auctioned item.

3. The method of claim 1 further comprising:
if no bids are received in the new auction, generating a new suggested minimum bid; and
sending the new suggested minimum bid to seller.

4. The method of claim 1 further comprising
receiving a Web form from the successful bidder; and
retrieving any modified pre-populated data from the Web form, wherein the previously-auctioned item is reposted using the modified data.

5. The method of claim 4 further comprising, if the winning bidder declines to resell, inviting the winning bidder to repost said previously-auctioned item after a predetermined time interval.

6. The method of claim 3 further comprising resetting said minimum bid price in response to an affirmative reply from said winning bidder.

7. The method of claim 2 wherein said suggested minimum bid is generated using an extrapolation from previous bidding activity.

8. A computer program product embodied in a tangible storage medium, the program product comprising programming instructions for:
generating a suggested minimum bid and suggested auction duration for a previously-auctioned item;
sending the existing item description, suggested minimum bid and suggested auction duration to a winning bidder and querying said winning bidder to resell the previously-auctioned item;
responsive to a receipt of an affirmative reply from the winning bidder, reposting the previously-auctioned item for a new auction; and
notifying previously unsuccessful bidders that the previously-auctioned item is reposted.

9. The computer program product of claim 8 further comprising programming instructions for generating said suggested minimum bid using historical bids from a previous auction of said previously-auctioned item.

10. The computer program product of claim 8 further comprising:
if no bids are received, generating a new suggested minimum bid; and
sending the new suggested minimum bid to seller.

11. The computer program product of claim 8 further comprising circuitry operable for:
receiving a Web form from the successful bidder; and
retrieving any modified pre-populated data from the Web form, wherein the previously-auctioned item is reposted using the modified data.

12. The computer program product of claim 11 further comprising programming instructions for, if the winning bidder declines to resell, inviting the winning bidder to repost said previously-auctioned item after a predetermined time interval.

13. The computer program product of claim 10 further comprising programming instructions for:
resetting said minimum bid price in response to an affirmative reply from said winning bidder.

14. The computer program product of claim 9 wherein said suggested minimum bid is generated using an extrapolation from previous bidding activity.

15. A data processing system for reselling items in a network auction comprising:
generating a suggested minimum bid and suggested auction duration for a previously-auctioned item;
sending the existing item description, suggested minimum bid and suggested auction duration to a winning bidder and querying said winning bidder to resell the previously-auctioned item;
responsive to a receipt of an affirmative reply from the winning bidder, reposting the previously-auctioned item for a new auction; and
notifying previously unsuccessful bidders that the previously-auctioned item is reposted.

16. The data processing system of claim 15 further comprising circuitry operable for generating said suggested minimum bid using historical bids from a previous auction of said previously-auctioned item.

17. The data processing system of claim 15 further comprising:
if no bids are received, generating a new suggested minimum bid; and
sending the new suggested minimum bid to seller.

18. The data processing system of claim 15 further comprising circuitry operable for:
receiving a Web form from the successful bidder; and
retrieving any modified pre-populated data from the Web form, wherein the previously-auctioned item is reposted using the modified data.

19. The data processing system of claim 18 further comprising circuitry operable for, if the winning bidder declines to resell, inviting the winning bidder to repost said previously-auctioned item after a predetermined time interval.

20. The data processing system of claim 17 further comprising circuitry operable for:
resetting said minimum bid price in response to an affirmative reply from said winning bidder.
